(19) United States
(12) Patent Application Publication
(10) Pub. No.: US 2022/0048169 A1
(43) Pub. Date: Feb. 17, 2022

(54) REMOVAL TOOL FOR SCREW-ON CANISTER FILTERS

(71) Applicants: Nicholas Allen Sands, Holly, MI (US); Clifford George Sands, Holly, MI (US)

(72) Inventors: Nicholas Allen Sands, Holly, MI (US); Clifford George Sands, Holly, MI (US)

(21) Appl. No.: 16/990,308

(22) Filed: Aug. 11, 2020

(51) Int. Cl. B25B 27/00; B25B 13/48; B25B 13/50

(52) U.S. Cl. CPC B25B 27/0042; B25B 13/5008; B25B 13/481

(57) ABSTRACT

A removal tool for a screw-on canister filter comprising a plurality of a tooth and side apertures. The tooth comprises of a chisel edge, bevel surface, and receding surface. The chisel edge of each tooth has an interference fit to the filter and it located on the center of a filter scallop. The side apertures allow the metal canister of the filter to contort and grant access to the filter bottom.

### BACKGROUND OF THE INVENTION

### 1. Field of the Invention

The present invention is in the field of removal tools for filters and pertains particularly to removal tools for screw-on canister filters.

### 2. Description of Related Art

Internal combustion engines have periodic maintenance involving the changing of oil. During an oil changing process, an oil filtration device is removed from an engine and replaced along with oil. A common style of an oil filtration device is a screw-on canister filter. A screw-on canister filter will normally need replacement after contaminates have saturated its filtration media for a required purpose. Most commonly, screw-on canister filters are used in oil applications, such as automobile oil. Commonly used methods for the removal of screw-on canister filters involve a tool or device to transfer force onto a filter canister which influences rotation for unscrewing. After many hot-cold cycles, screw-on canister filters have a tendency to become intensely adhered to an engine. Once a screw-on canister filter has become extremely attached, a filter is overwhelmingly resistant to removal.

Existing removal tools for screw-on canister filters will slip, deform, fail or break when removing an extremely attached filter. In some instances, the metal canister of a filter will deform before it will rotate. Currently available removal tools for screw-on canister filters are marginally effective under ideal scenarios and most often completely ineffective when attempting to remove an extremely attached filter. In many applications, existing tools are often impotent due to limited accessibility of filters within an engine compartment. Existing removal tools that can be installed in confined spaces are often unable to secure a filter with a level of retention that is capable of transferring torque necessary for rotating an extremely attached filter. This can be caused by the size-for-size or clearance fits found in present tools not being able to adequately secure the filter. In addition, some existing removal tools will not retain themselves to a filter making it harder to manage the tool in confined spaces. Another fault with some existing removal tools is they attempt to accommodate multiple filter configurations within one tool design rather than targeting a single application. The retention, strength and ability of existing multi-filter tools are most often compromised due to attributes of a multipurpose design. An additional fault with some existing removal tools is they do not provide an avenue for separation of a removal tool and filter after the adjoined pair have been extracted from an engine compartment.

Therefore, what is clearly needed is a removal tool and method for removing canister filters that solves the problems mentioned above.

### BRIEF SUMMARY OF THE INVENTION

The aforementioned problems have been recognized and inspire the need of an improved removal tool for screw-on disposable filters.

The primary objective of the present invention is to create a removal tool for screw-on disposable filters with increased grip that allows an operator to apply a high level of torque without slipping on the canister, especially when working in confined spaces. In addition to this objective, once the screw-on canister filter is extracted from an engine bay, the removal tool can be separated easily from the filter.

To achieve the primary objective, a characteristic of a removal tool in accordance with the present invention, would require the manufacture of said tool from a ferrous-based alloy to reduce tool deformation during use and permit thinner material cross sections ideal for use in confined spaces.

Another attribute for achieving the objective is the removal tool will engage the filter strategically on driving edges with an interference fit to increase grip and allow for the influence of more torque. The driving edges and accompanying surfaces will have optimized geometry that will only be useful for one specific size and shape filter, as a result, maximizing filter retention and allowing the exertion of the high level of required torque.

An additional assisting feature for achieving the objective is that the removal tool will not fully encompass a filter. Adding apertures to the removal tool on two opposing quadrants will permit the canister of the filter to contort when the removal tool is installed and thus allowing for an interference fit of the driving edges. Expanding on the benefits, having apertures allows access to the underside of the filter with a screw driver or like tool which can easily pry and separate the removal tool from the filter after use. In addition, apertures can be used to clear engine components when utilized in confined spaces.

### BRIEF DESCRIPTION OF THE SEVERAL VIEWS OF THE DRAWINGS

FIG. 1 is an isometric view depicting the inside of a removal tool according to an embodiment of the present invention.

FIG. 2 is an isometric view depicting the outside of the removal tool of FIG. 1 according to an embodiment of the present invention.

FIG. 3 is a side view of the removal tool of FIG. 1 shown in a utilized state upon a screw-on canister filter withheld in an engine depicting motion in an attach direction according to an embodiment of the present invention.

FIG. 4A is a section view of the removal tool of FIG. 3 according to an embodiment of the present invention.

FIG. 4B is a detail view of the removal tool of FIG. 4A according to an embodiment of the present invention.

FIG. 5 is an isometric view depicting the inside of the removal tool of FIG. 1 shown in a utilized state upon a screw-on canister filter depicting motion in a removal direction according to an embodiment of the present invention.

FIG. 6 is an isometric view depicting the outside of the removal tool of FIG. 1 shown in a utilized state upon a screw-on canister filter according to an embodiment of the present invention.

### DETAILED DESCRIPTION OF THE INVENTION

The inventor provides a removal tool for screw-on canister filters that provides a tight grip allowing an operator to apply a high level of torque without slipping on a canister when working in confined spaces. The present invention is described in enabling detail in the following examples, which may represent more than one embodiment of the present invention.

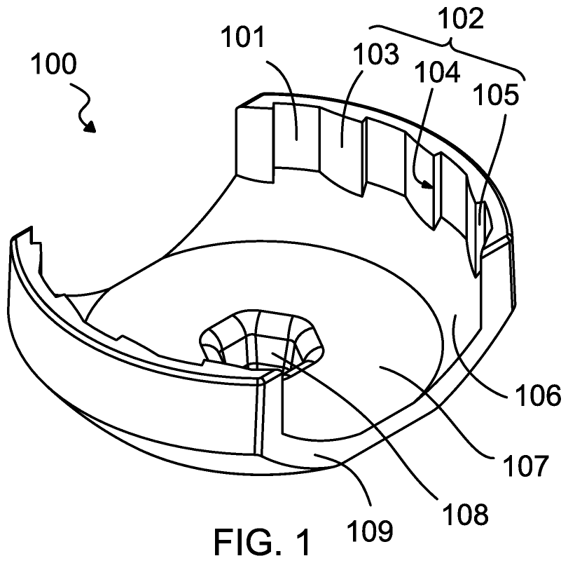

FIG. 1 is an isometric view depicting the inside of a removal tool 100 according to an embodiment of the present invention. Removal tool 100 in this embodiment is designed to remove a screw-on canister filter of an internal combustion engine or similar device. More specifically, applications in which a screw-on canister filter is withheld in confined spaces of an engine. In a preferred embodiment, it is envisioned removal tool 100 would be manufactured from a ferrous-based alloy to reduce tool deformation. Secondly, the ferrous-based alloy would permit removal tool 100 to be manufactured with thinner cross sections of material ideal for utilization in confined spaces. The primary purpose of removal tool 100 is for the removal of a screw-on canister filter.

In a preferred embodiment, removal tool 100 has a plurality of a tooth 102 comprising of a chisel edge 104, a bevel surface 103, and a receding surface 105. Chisel edge 104 is defined by the edge formed between the bevel surface 103 and receding surface 105. Bevel surface 103 reinforces chisel edge 104 for increased strength during rotation of removal tool 100. In this example, receding surface 105 is perpendicular to bevel surface 103. The perpendicularity will sharpen a corner for chisel edge 104 to tightly engage on a screw-on canister filter. Therebetween each tooth 102 is a relief surface 101 that has clearance and does not contact a screw-on canister filter during use. Further iterations of a removal tool 100 comprising a tooth 102 and relief surface 101 can be created to accommodate different sizes and shapes of a screw-on canister filter.

In a preferred embodiment, tooth 102 and relief surface 101 will extend to an interior chamfer 106 surface to give more strength to removal tool 100. In this example, a side aperture 109 is an opening on the side of removal tool 100 to allow access to an interior flat surface 107. Another embodiment is a pocket 108 within removal tool 100 to lighten and prevent defects from manifesting when manufactured from cast metal solidification processes.

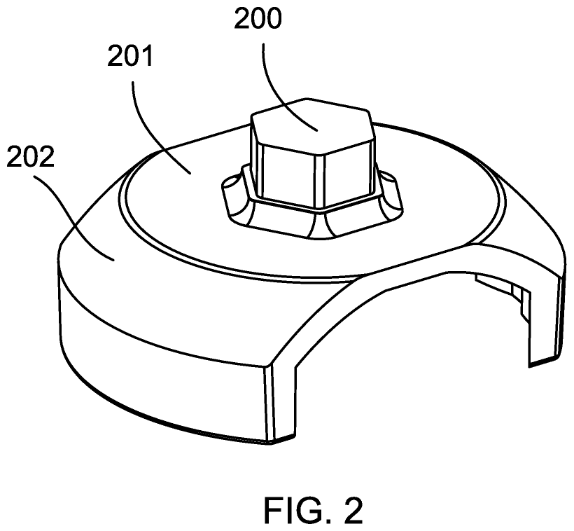

FIG. 2 is an isometric view depicting the outside of the removal tool 100 of FIG. 1 according to an embodiment of the present invention. In this example, a socket hex 200 allows an operator to use external tools such as a socket or wrench for applying torque on removal tool 100. An exterior chamfer surface 202 is an offset of interior chamfer surface 106 to reduce unneeded material and lighten removal tool 100. Similarly, an exterior flat surface 201 is an offset of the interior flat surface 107 to reduce unneeded material and lighten removal tool 100.

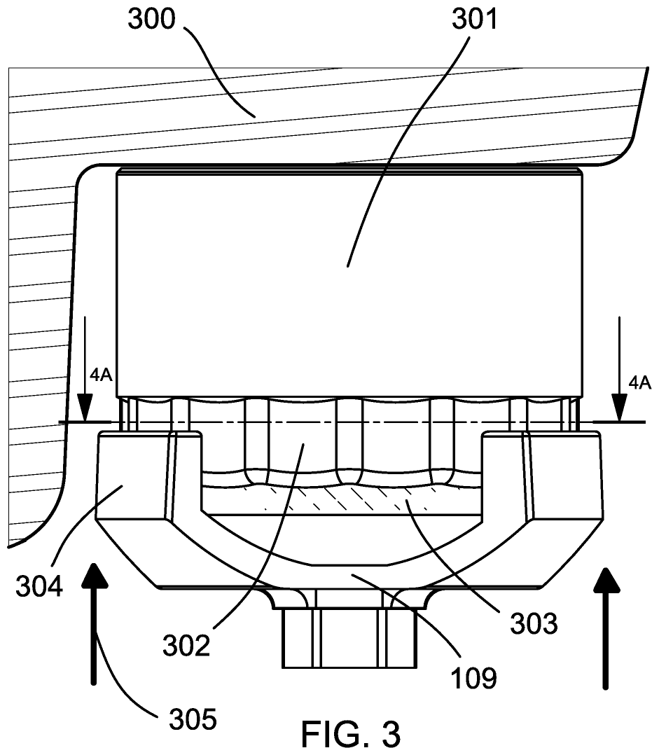

FIG. 3 is a side view of the removal tool 100 of FIG. 1 shown in a utilized state upon a screw-on canister filter 301 withheld in an engine 300 depicting motion in an attach direction 305 according to an embodiment of the present invention. Removal tool 100 will adjoin to a screw-on canister filter 301 from a force in an attach direction 305. In a preferred embodiment, the force of an operator's hand pushing on removal tool 100 in an attach direction 305 will be able to adjoin removal tool 100 to a screw-on canister filter 301. When adjoining the removal tool 100 and screw-on canister filter 301 each tooth 102 will contact a filter scallop 302. In a preferred embodiment, the removal tool 100 will have enough grip that it will be able to retain its self and hang on a screw-on canister filter 301 without an operator holding it. Removal tool 100 will be fully attached to a screw-on canister filter 301 once interior chamfer surface 106 contacts a filter bottom 303. An interior flat surface 107 has clearance to filter bottom 303 to ensure every tooth 102 will be completely engagement to a filter scallop 302. An exterior ring 304 maintains a contoured shape to reduce unneeded material to help clear the removal tool 100 from an engine 300. In this example, a side aperture 109 on two opposing quadrants will permit the metal casing of a screw-on canister filter 301 to contort when the removal tool 100 is installed. From the contortion of screw-on canister filter 301, it enables the chisel edge 104 to have an interference fit on a filter scallop 302. Secondly, side aperture 109 will benefit tool use in confined spaces by having less material to interfere with.

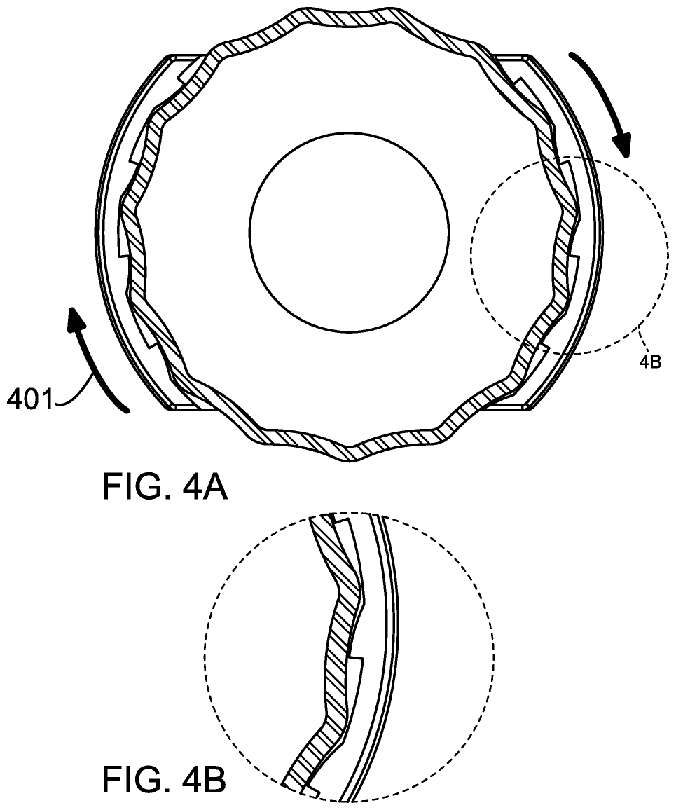

FIG. 4A is a section view of the removal tool 100 of FIG. 3 according to an embodiment of the present invention. Tooth 102 and relief surface 101 are directional and their primary purpose is to spin in a removal direction 401 as they will only be effective in the removal direction 401.

FIG. 4B is a detail view of the removal tool 100 of FIG. 4A according to an embodiment of the present invention. This embodiment includes components that were previously introduced in FIG. 1 and FIG. 3. Those components that are unchanged in this embodiment retain their original element numbers and are not reintroduced. In a preferred embodiment, chisel edge 104 is to be located on the center of filter scallop 302 during tool utilization. Bevel surface 103 imitates the same contour as filter scallop 302 with clearance until it reaches chisel edge 104. In this embodiment, chisel edge 104 will be the only point of contact of a tooth 102 to a filter scallop 302. Chisel edge 104 will have an interference fit to filter scallop 302 delivering a biting grip, thereby preventing tool slippage and granting high torque in a removal direction 401.

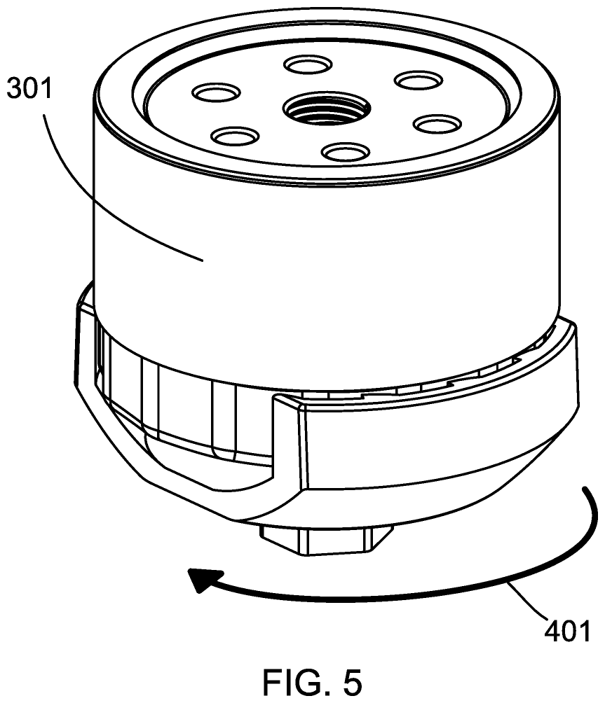

FIG. 5 is an isometric view depicting the inside of the removal tool 100 of FIG. 1 shown in a utilized state upon a screw-on canister filter 301 depicting motion in a removal direction 401 according to an embodiment of the present invention. Removal tool 100 will spin in a removal direction 401 to loosen the screw-on canister filter 301 from the engine 300. During the loosening process oil will be dripping down the screw-on canister filter 301 and on to removal tool 100. The used oil will act as an additional rust preventative for removal tool 100 when comprising of a ferrous based alloy.

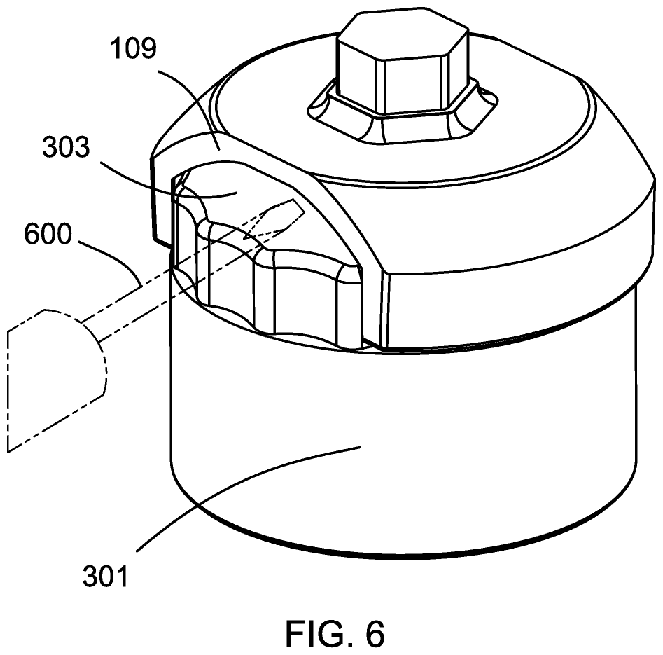

FIG. 6 is an isometric view depicting the outside of the removal tool 100 of FIG. 1 shown in a utilized state upon a screw-on canister filter 301 according to an embodiment of the present invention. In this embodiment, side aperture 109 allows access to the filter bottom 303. This access to filter bottom 303 allows an external tool 600 to be used in a manner to pry and separate removal tool 100 from a screw-on canister filter 301. In this example, a screw driver is used for external tool 600 to separate the adjoined pair after they have been extracted from the engine 300.

To utilize the removal tool, the following procedure would be followed; the internal combustion engine or similar device would be prepped for an oil and filter change following existing well-known procedures; existing oil would be removed, drained and captured. The removal tool would be pressed on to the screw-on canister filter by an operator until the interior chamfer surface contacts the screw-on canister filter. The user would use an external tool that corresponds to a socket hex and apply torque to the removal tool in the removal direction until the screw-on canister filter un-screws. After the adjoined pair have become unscrewed and separated from the internal combustion engine or similar device, the removal tool would be separated from the screw-on canister filter by prying the filter through a side aperture with a screwdriver or like tool until the removal tool is separated from the screw-on canister filter.

It will be apparent to one with skill in the art that the removal tool invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A removal tool for a screw-on canister filter, comprising:
a tooth having a chisel edge, a bevel surface, and a receding surface;
said tooth has an interference fit to a screw-on canister filter;
a side aperture allowing access to a filter bottom;

2. The removal tool of claim 1, further comprising a plurality of said tooth.

3. The removal tool of claim 1, further comprising a plurality of said side aperture.

4. The removal tool of claim 1, wherein said tooth comprises a chisel edge to be located on a center of a filter scallop.

5. The removal tool of claim 1, further comprising of a ferrous-based alloy.
